(19) United States
(12) Patent Application Publication
(10) Pub. No.: US 2010/0154522 A1
(43) Pub. Date: Jun. 24, 2010

(54) METHOD AND DEVICE FOR DETERMINING THE "PHASING" OF AN INTERNAL COMBUSTION "V" ENGINE

(75) Inventors: Laure Carbonne, Toulouse (FR); Alain Gonzalez, Castelginest (FR); Roger Rouphael, L'Union (FR); Robertus Vingerhoeds, Toulouse (FR)

Correspondence Address: YOUNG & THOMPSON, 209 Madison Street, Suite 500, Alexandria, VA, 22314, US

(73) Assignee: CONTINENTAL AUTOMOTIVE FRANCE, Toulouse (FR)

(21) Appl. No.: 12/593,728

(22) PCT Filed: Mar. 27, 2008
(86) PCT No.: PCT/EP08/02397

§ 371 Date: Mar. 2, 2010

(30) Foreign Application Priority Data
Mar. 30, 2007 (FR) 07/02329

(51) Int. Cl. G01M 15/04

(52) U.S. Cl. 73/114.32

(57) ABSTRACT

A method of determining the “phasing” of an internal combustion engine includes two banks of cylinders each supplied by its own intake manifold. This determining method consists, on the one hand, in equipping each intake manifold with an air flow meter and in measuring the air flow rate in each of the manifolds so as to detect an increase in the air flow rate in one of the manifolds representative of an intake of air into the bank of cylinders supplied by the manifold, and, on the other hand, in equipping one of the rotary members, crankshaft or camshaft associated with each bank of cylinders with a target that rotates as one with the rotary member and is able to determine which cylinder of the bank of cylinders determined to be in the intake phase is in the air intake phase.

The invention relates to a method of determining the “phasing” (that is to say a method of determining the position of the pistons in their respective cylinders and of determining the engine stroke in which they are engaged) of an internal combustion “V” engine comprising two banks of cylinders each supplied by its own intake manifold. It also extends to a device intended to implement this method.

The starting of present-day internal combustion engines requires precise knowledge of the “phasing” of this engine so as to allow the computer that controls said engines (often known by their English acronyms “EMS” or “ECU” which respectively denote “engine management system” and “engine control unit”) to best control the injection and thus guarantee a rapid, effective and non-polluting start.

One conventional solution used for this purpose is to equip the crankshaft with a toothed target that rotates as one with said crankshaft, and in determining the angular position of said target using an incremental sensor. In addition, each toothed target has a reference mark designed so that counting off the teeth encountered by the incremental sensor starting from this reference mark allows the position of the pistons to be determined.

However, the full cycle of a four-stroke internal combustion engine corresponds to two full revolutions of a crankshaft, which means that after the data supplied by the incremental sensor associated with the crankshaft have been examined there still remains an uncertainty of 360°.

In order to remove this uncertainty, the usual solution is to equip the camshaft with a target that rotates as one with said camshaft, and in determining the angular position of said target using a second incremental sensor. Because the camshaft performs one full revolution during a four-stroke engine cycle, the 360° uncertainty can therefore thus be removed.

According to this principle, a comparison between the data from the two sensors allows the control computer to determine the “phasing” of the engine and initiate a start under good conditions.

One first disadvantage with such a procedure still results from the need to equip each of the rotary members of the engines, crankshaft and camshaft, with a target, with an incremental sensor, with the related electronics, etc. That leads to a relatively high cost price.

In addition, any malfunctioning of any one of the aforementioned elements (target and/or sensor) means that the control computer is deprived of the information it needs to determine the “phasing” of the engine.

The present invention aims to alleviate these disadvantages and its main objective is to allow the “phasing” of such an engine to be determined using a single target with which one of the rotary members associated with each bank of cylinders of said engine is equipped.

To this end, the invention is aimed firstly at a method of determining the “phasing” of an internal combustion “V” engine comprising two banks of cylinders each supplied by its own intake manifold, said determining method consisting:
in equipping each intake manifold with an air flow meter and in measuring the air flow rate in each of said manifolds so as to detect an increase in the air flow rate in one of said manifolds representative of an intake of air into the bank of cylinders supplied by said manifold,
and in equipping one of the rotary members, crankshaft or camshaft associated with each bank of cylinders with a target that rotates as one with said rotary member and is able to determine which cylinder of the bank of cylinders determined to be in the intake phase is in the air intake phase.

It should be noted that “one of the rotary members, crankshaft or camshaft, associated with each bank of cylinders” is supposed to specify that there is either a target associated with the single crankshaft or there are two targets each one associated with one of the two camshafts.

The basis of the invention has been to employ and to exploit the fact whereby there is an offset between the signal representative of the air flow rate in the intake manifold of one of the banks of cylinders and the flow rate signal from the intake manifold of the other bank of cylinders because of the fact that the air flow rate increases in an intake manifold if one of the cylinders of that bank of cylinders supplied by that manifold is in the intake phase.

Thus, during the start, the cylinder that is the first to enter the intake phase generates, in the intake manifold supplying the bank of cylinders that incorporate said cylinder, an increase in air flow rate which occurs in a space of time of the order of the duration of a cycle, before the air flow rate in the intake manifold supplying the other bank of cylinders increases.

Because a flow rate measurement can be performed in the conventional way during each cycle, such an offset can easily be detected and makes it possible to deduce which bank of cylinders contains the cylinder that is in the intake phase.

Combined with information, obtained according to a conventional method, representative of the angular position of a target associated with a rotary member, this first piece of information then makes it possible to determine which cylinder of the bank of cylinders determined to be in the intake phase is in the air intake phase.

Thus, the method according to the invention makes it possible to determine the “phasing” of a “V” engine by means of the use of just one target associated with one rotary member, and of flow meters commonly installed in present-day engines with a view to optimizing the control of said engines.

In addition, the responsiveness of this method is comparable with that of the present-day methods because the detection of the increase in flow rate in one of the intake manifolds can occur after just one or perhaps two engine cycle(s).

As far as the target is concerned, this may advantageously be associated with the engine crankshaft. If it is, the information relating to which cylinder is in the intake phase can be deduced directly from the data relating to the angular position of this target which are supplied by an incremental sensor associated with this target in the conventional way.

It should nonetheless be noted that, according to another embodiment of the invention, a target could equally be associated with each camshaft assigned to one bank of cylinders.

If it is, then it is nonetheless appropriate, with a view to determining which cylinder is in the intake phase, to perform an additional processing operation that involves analyzing the time offset between the moments separating detection of the increase in air flow rate in the intake manifold and detection of the characteristic fronts of the camshaft targets.

Furthermore, the method according to the invention can be implemented mainly with a view to determining the “phasing” of the engines, that is to say intended to be implemented in new vehicles from the outset.

This method of determining the “phasing” could equally be implemented as a troubleshooting tool in the event of a malfunctioning of one of the targets equipping an engine the crankshaft and the two camshafts of which are each equipped with targets.

When it is, during normal operation of the targets, the signals delivered by the flow meters are regularly “learned” so as to evaluate and control the spread on said signals, which proves to be specific to each engine.

The invention extends to a device for determining the “phasing” of an internal combustion “V” engine comprising two banks of cylinders each supplied by its own intake manifold. According to the invention, this device for determining the “phasing” comprises:
an air flow meter incorporated into each intake manifold and means of analyzing the measurements supplied by each of said meters, these means being designed to detect an increase in the air flow rate in one of said manifolds which is representative of an intake of air into the bank of cylinders supplied by said manifold,
a target that rotates as one with at least one of the rotary members, crankshaft or camshaft, associated with each bank of cylinders,
and means of detecting the angular position of the target which are able to determine which cylinder of the bank of cylinders determined to be in the intake phase is in the air intake phase.

Other features, objects and advantages of the invention will become apparent from the detailed description which follows, with reference to the attached drawings which, by way of nonlimiting example, depict a preferred embodiment thereof. In these drawings:

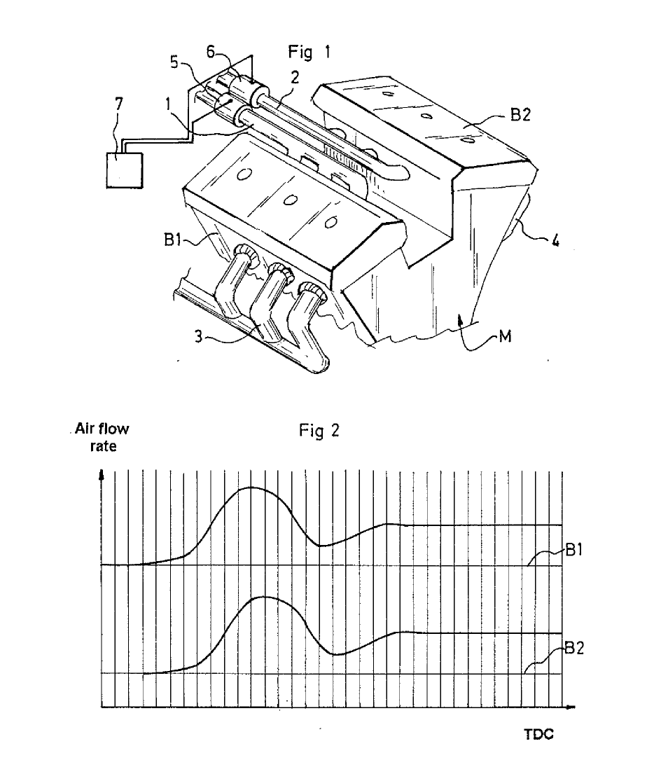

FIG. 1 is a schematic perspective view of an engine equipped with a device according to the invention for determining the “phasing” of said engine,

and FIG. 2 is a graph representing the measurement signals from the two flow meters with which this determining device is equipped.

The invention described hereinbelow with reference to the figures is intended to enable the “phasing” of an internal combustion “V” engine M, comprising two banks B1, B2 of cylinders each for example incorporating three to six cylinders, to be determined, each of said banks of cylinders being supplied by means of its own intake manifold 1, 2 and being connected to its own exhaust manifold 3, 4.

It should be noted, as is usual, that the two intake manifolds 1, 2 and likewise the two exhaust manifolds 3, 4 may be either separate over their entire length or have some degree of overlap.

According to the invention, the device for determining the “phasing” of this engine M comprises two air flow meters 5, 6 each incorporated into an intake manifold 1, 2 and connected to means 7 of analyzing the measurements supplied by each of said meters.

According to the principle of the invention, and as depicted in FIG. 2, these analysis means 7 are designed to make it possible, when the engine M is being started, to detect an increase in the air flow rate in one of the intake manifolds (1 manifold in the example):
representative of an intake of air into the bank B1 of cylinders supplied by said manifold,
which occurs a period of time of the order of the duration of a cycle (the time separating two “top dead centers” TDC) before the increase in air flow rate in the intake manifold 2 supplying the other bank B2 of cylinders.

Such analysis means thus make it possible to determine which bank of cylinders, B1 in the example, contains a cylinder in the intake phase.

The determining device according to the invention further comprises means of determining which cylinder of the bank B1 of cylinders determined to be in the intake phase is in the air intake phase.

These means known per se are not depicted and may, for example, comprise:
a target that rotates as one with the crankshaft of the engine M,
and means of detecting the angular position of the target which are able to determine which cylinder of the bank B1 of cylinders determined to be in the intake phase is in the air intake phase.

The device according to the invention therefore makes it possible to determine the “phasing” of a “V” engine M through the use of a single target associated with a rotary member and of flow meters 5, 6 such as are already commonly installed in present-day engines with a view to optimizing the control of said engines.

1. A method of determining the “phasing”, that is to say of determining the position of the pistons in their respective cylinders and of determining the engine stroke, of an internal combustion “V” engine (M) comprising two banks (B1, B2) of cylinders each supplied by its own intake manifold (1, 2), said determining method being characterized in that it consists:
in equipping each intake manifold (1, 2) with an air flow meter (5, 6) and in measuring the air flow rate in each of said manifolds so as to detect an increase in the air flow rate in one of said manifolds representative of an intake of air into the bank (B1, B2) of cylinders supplied by said manifold,
and in equipping one of the rotary members, crankshaft or camshaft associated with each bank (B1, B2) of cylinders with a target that rotates as one with said rotary member and is able to determine which cylinder of the bank (B1, B2) of cylinders determined to be in the intake phase is in the air intake phase.

2. The method of determining the “phasing” as claimed in claim 1, whereby a target is associated with the engine crankshaft.

3. The method of determining the “phasing” as claimed in claim 1, whereby a target is associated with each camshaft assigned to one bank (B1, B2) of cylinders.

4. The method of determining the “phasing” as claimed in claim 1, intended to be performed for the purposes of troubleshooting in the event of a malfunctioning of one of the targets equipping an engine (M) the crankshaft and the two camshafts of which are each equipped with targets, characterized in that, during normal operation of said targets, the signals delivered by the flow meters (5, 6) are regularly “learned” so as to evaluate and control the spread on said signals.

5. A device for determining the “phasing” of an internal combustion “V” engine (M) comprising two banks (B1, B2) of cylinders each supplied by its own intake manifold (1, 2), said determining device being characterized in that it comprises, in combination:
an air flow meter (5, 6) incorporated into each air intake manifold (1, 2) and means (7) of analyzing the measurements supplied by each of said meters, these means being designed to detect an increase in the air flow rate in one of said manifolds which is representative of an intake of air into the bank (B1, B2) of cylinders supplied by said manifold,
a target that rotates as one with at least one of the rotary members, crankshaft or camshaft, associated with each bank (B1, B2) of cylinders,
and means of detecting the angular position of the target which are able to determine which cylinder of the bank (B1, B2) of cylinders determined to be in the intake phase is in the air intake phase.

6. The method of determining the “phasing” as claimed in claim 2, intended to be performed for the purposes of troubleshooting in the event of a malfunctioning of one of the targets equipping an engine (M) the crankshaft and the two camshafts of which are each equipped with targets, characterized in that, during normal operation of said targets, the signals delivered by the flow meters (5, 6) are regularly “learned” so as to evaluate and control the spread on said signals.

7. The method of determining the “phasing” as claimed in claim 3, intended to be performed for the purposes of troubleshooting in the event of a malfunctioning of one of the targets equipping an engine (M) the crankshaft and the two camshafts of which are each equipped with targets, characterized in that, during normal operation of said targets, the signals delivered by the flow meters (5, 6) are regularly “learned” so as to evaluate and control the spread on said signals.
